(19) United States
(12) Patent Application Publication
(10) Pub. No.: US 2003/0033255 A1
(43) Pub. Date: Feb. 13, 2003

(54) License repository and method

(76) Inventors: Margaret Jane Burton, Boise, ID (US); Janine Louise Helms, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/928,942

(22) Filed: Aug. 13, 2001

(51) Int. Cl. G06F 17/60

(52) U.S. Cl. 705/59

(57) ABSTRACT

A license repository and method for maintaining the same are provided. In one embodiment, the method comprises the steps of maintaining a number of entities in the license repository in a server, the number entities including a number of licensors and a number of licensee, generating a number of licenses between respective pairs of the licensees and the licensors based upon an input from at least one of the licensees and the licensors, respectively, and, maintaining the licenses in the license repository.

### TECHNICAL FIELD

The present invention is generally related to the field of licensing and, more particularly, is related to a license repository and method.

### BACKGROUND OF THE INVENTION

Computer software companies are more and more asserting their rights to stop the use of unlicensed copies of software that are used by various individuals and corporations. From time to time, audits are now being performed to ensure that individuals and corporations are in compliance with copyright laws as they relate to software products installed on computer devices. For violators of the copyright laws, the monetary penalties can be significant.

In response to recent audit activity and to ensure compliance with copyright laws, many individuals and companies have sought to ensure they are in compliance such that proper licenses are obtained for all software products installed on their computer systems.

However, for large corporations, for example, ensuring proper compliance is not very easy. Typically large corporations purchase large site licenses for software use. However, individual employees and managers may not have a way of knowing what software is licensed and what is not. Consequently, to ensure proper compliance with copyright laws, new copies of software may be purchased unnecessarily. For instance, in circumstances where a corporation has a site license that is underutilized in that several unused licenses for the software exist, a purchase of a new license is a waste of money. In other circumstances, employees and managers may install software under the erroneous assumption that a site license covers their installation when the number of copies used is greater than the number allowed under the site license.

### SUMMARY OF THE INVENTION

In light of the foregoing, the present invention provides for a license repository and method for maintaining the same. In one embodiment, the method comprises the steps of maintaining a number of entities in the license repository in a server, the number entities including a number of licensors and a number of licensees, generating a number of licenses between respective pairs of the licensees and the licensors based upon an input from at least one of the licensees and the licensors, respectively, and, maintaining the licenses in the license repository.

In another embodiment, the present invention provides for a system for maintaining a license repository. In this respect, the system comprises means for maintaining a number of entities in the license repository in a server, the number entities including a number of licensors and a number of licensees, means for generating a number of licenses between respective pairs of the licensees and the licensors based upon an input from at least one of the licensees and the licensors, respectively, and, means for maintaining the licenses in the license repository.

In still another embodiment, the present invention provides for a program embodied on a computer-readable medium for maintaining a license repository. In this respect, the program comprises code that maintains a number of entities in the license repository, the number entities including a number of licensors and a number of licensees, code that generates a number of licenses between respective pairs of the licensees and the licensors based upon an input from at least one of the licensees and the licensors, respectively, and code that maintains the licenses in the license repository.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a licensing network that includes a license repository according to an aspect of the present invention;

FIG. 2 is a drawing of a graphical user interface (GUI) generated on a client device in the licensing network of FIG. 1 that depicts an introductory page presented to a licensee;

FIG. 3 is a drawing of a GUI generated on the client device in the licensing network of FIG. 1 that depicts a licensee profile;

FIG. 4 is a drawing of a GUI generated on the client device in the licensing network of FIG. 1 that depicts a license portfolio of a licensee;

FIG. 5 is a drawing of a GUI generated on the client device in the licensing network of FIG. 1 that depicts a number of registered licensors;

FIG. 6 is a drawing of a GUI generated on the client device in the licensing network of FIG. 1 that depicts a number of license offerings by a licensor;

FIG. 7 is a drawing of a GUI generated on the client device in the licensing network of FIG. 1 that depicts a licensor profile;

FIG. 8 is a drawing of a GUI generated on the client device in the licensing network of FIG. 1 that depicts an introductory page presented to a licensor;

FIG. 9 is a drawing of a GUI generated on the client device in the licensing network of FIG. 1 that depicts a license portfolio of a licensor;

FIG. 10 is a flow chart of license repository control logic implemented in a license repository server of FIG. 1 in conjunction with the GUIs of FIGS. 4 and 9;

FIG. 11 is a flow chart of license repository control logic implemented in a license repository server of FIG. 1 in conjunction with the GUI of FIG. 6; and

FIG. 12 is a flow chart of license repository control logic implemented in a license repository server of FIG. 1 in conjunction with the GUIs of FIGS. 3 and 7.

### DETAILED DESCRIPTION OF THE INVENTION

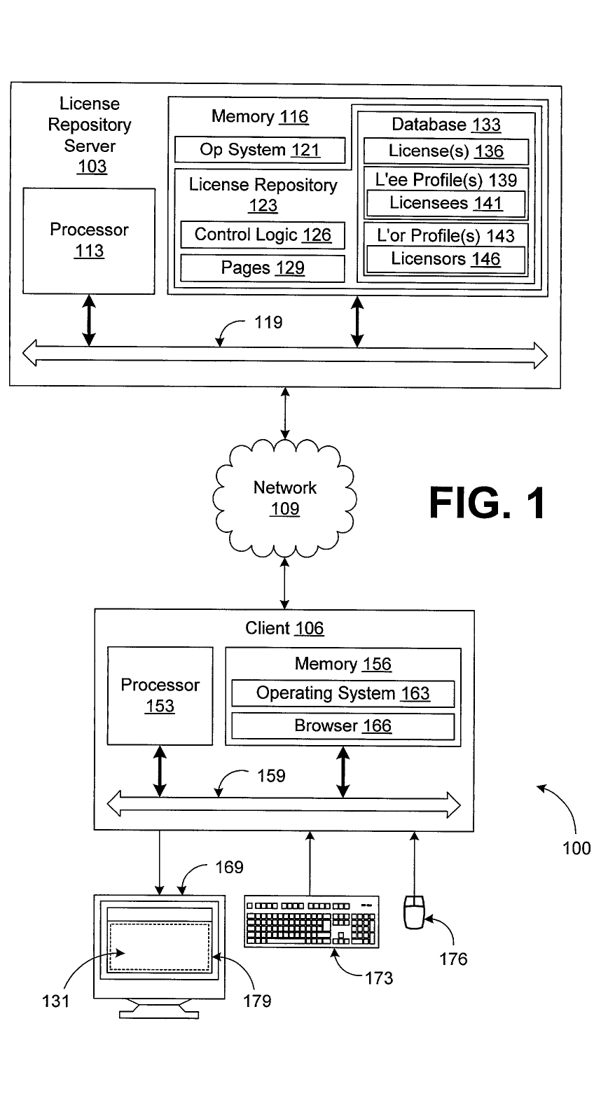

With reference to FIG. 1, shown is a licensing network 100 according to an aspect of the present invention. The licensing network 100 includes a license repository server 103 and a client 106, both of which are coupled to a network 109. In this respect, the license repository server 103 and the client 106 may each be computer systems or other systems with like capability as is generally understood by those with ordinary skill in the art. In this respect, the license repository server 103 includes a processor circuit with a processor 113 and a memory 116, both of which are coupled to a local interface 119. The local interface 119 may be, for example, a data bus with an accompanying control/address bus as is generally known by those with ordinary skill in the art.

Stored on the memory 116 and executable by the processor 113 are an operating system 121 and a license repository 123. The license repository 123 includes, for example, control logic 126, various network pages 129, and a database 133. The database 133 contains a number of licenses 136. The database 133 also includes a number of licensee profiles 139, where each licensee profile 139 provides information about a specific licensee 141. Similarly, the database 133 also includes a number of licensor profiles 143, each licensor profile providing information about a specific licensor 146. The licensees 141 and licensors 146 may be any entity such as, for example, a person, corporation, or other entity. In this respect, each of the licensees 141 and licensors 146 party to at least one license 136 maintained in the database 133.

In maintaining the licenses 136, licensee profiles 139, and licensor profiles 143, the control logic 126 is executed at appropriate times to perform various additions, modifications, updates, or other actions relative to the licenses 136, the licensee profiles 139, or the licensor profiles 143. Such functionality will be discussed in greater detail in text that follows.

The client 106 also includes a processor circuit that comprises a processor 153 and a memory 156, both of which are coupled to a local interface 159. In this respect, the local interface 159 may comprise a data bus with an accompanying control/address bus as is generally known by those with ordinary skill in the art. The client 106 also includes an operating system 163 and a browser 166, both of which are stored on the memory 156 and executable by the processor 153 as is generally known by those with ordinary skill in art. In this respect, the client 106 also includes a display device 169, a keyboard 173, and a mouse 176, all of which are coupled to the local interface 159 through appropriate interface cards or other such devices. The display device 169 may be, for example, a cathode ray tube (CRT), a liquid crystal display screen, a gas plasma-based flat panel display, or other suitable display device. In addition, the client 106 may include other peripheral devices such as, for example, a keypad, touch pad, touch screen, microphone, scanner, mouse, joystick, or one or more push buttons, etc. The peripheral devices may also include indicator lights, speakers, printers, etc. Also, the license repository server 103 may include similar peripheral devices to those employed by the client 106.

Upon executing the browser 166, a browser graphical user interface (GUI) 179 is displayed on the display device 169. Within the browser GUI 179 are graphical screens 131 that are generated from pages 129 by the browser 166. Specifically, the browser 166 downloads the pages 129 located on the license repository server 103 and generates the graphical screens 131 therefrom. In this respect, a user may manipulate the client 106 to download the pages 129 for viewing on the display device 169 using the browser 166.

The network 109 includes, for example, the Internet, wide area networks (WANs), local area networks, wireless networks, or other suitable networks, etc., or any combination of two or more such networks. The license repository server 103 and the client 106 are coupled to the network 109 to facilitate data communication to and from the network 109 in any one of a number of ways that are generally known by those of ordinary skill in the art. For example, both the license repository server 103 and the client 106 may be linked to the network 109 through various devices such as, for example, network cards, modems, or other such communications devices.

Also, the memories 116 and 156 each may include both volatile and nonvolatile memory components. Volatile components are those that do not retain data values upon loss of power. Nonvolatile components are those that retain data upon a loss of power. Thus, the memories 116 and 156 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Additionally, each of the processors 113 and 153 may represent multiple processors and each of the memories 116 and 156 may represent multiple memories that operate in parallel processing circuits, respectively. In such a case, each of the local interfaces 119 and 159 may be an appropriate network that facilitates communication between any two of the multiple processors, between any processor and any of the memories, or between any two of the memories, etc. The processors 113 and 153 may be electrical or optical in nature.

The operating systems 121 and 163 are executed to control the allocation and usage of hardware resources in the license repository server 103 and client 106, respectively. Specifically, the operating systems 121 and 163 control the allocation and usage of various portions of the memories 116 and 156, processing time, and the peripheral devices as well as performing other functionality. In this manner, the operating systems 121 and 163 serve as the foundation on which applications depend as is generally known by those with ordinary skill in the art.

Next, a general overview of the operation of the license repository 123 is provided. The license repository 123 is employed to maintain a number of licenses 136 between respective licensees 141 and licensors 146. These licenses 136 may be, for example, contractual license agreements for the use of software applications or other licenses as can be appreciated by those with ordinary skill in the art. The license repository 123 also maintains a number of entities, where each entity is either a licensee 141 or a licensor 146. In some cases a single entity may act in the capacity of a licensee 141 with respect to a first license 136, and as a licensor 146 with respect to a second license 136.

To maintain the number of licenses 136 in the license repository 123, the license repository 123 includes the database 133 that provides a compilation of the various licenses 136 as well as information relating to the licensees 141 and licensors 146 in the form of the licensee profiles 139 and the licensor profiles 143, respectively. A particular profile 139 or 143 may include, for example, address information such as a postal address or location and contact information such as an electronic mail (email) address, telephone number, fax number, or other contact information. A profile 139 or 143 may also include billing addresses, shipping addresses, and other pertinent information pertained to the field of contractual licensing as can be appreciated by those with ordinary skill in the art.

In maintaining contact information about the respective licensees 141 and licensors 146, the profiles 139 and 143 specifically include one or more points of contact for each licensee 141 and licensor 146. A point of contact may be, for example, an email address, a telephone number, or other means by which the respective entity maybe sent notification of various events that occur during the course of the operation of the licensee repository 123. Assume, for example, that the point of contact is an email address of a respective entity. In such case, the license repository 123 may provide automated notification of various events occurring during the maintenance of the license repository 123 to the respective entity by generating and transmitting an appropriate email message to such entity.

Note that the licensee profiles 139 and the licensor profiles 143 may differ in some respects. Specifically, the licensor profiles 143 may include, in addition to such information described above, a list of license products that are associated with the respective licensor 146. The license products constitute license product offerings that licensors 146 make to potential licensees 141 as can be appreciated by those with ordinary skill in the art.

The licenses 136 contained in the database 133 of the license repository 123 may be created by any entity, whether that entity is a licensee 141 or a licensor 146. A license may be, for example, a license contract by which a licensee 141 may receive the right to use various software applications on their computer from the licensor 146. Each of the licenses 136 includes a confirmation status. The confirmation status indicates whether both the respective licensee 141 and the licensor 146 have agreed to the creation of a respective license 136 in the license repository 123. Specifically, when one entity creates a respective license 136, whether they are a licensee 141 or licensor 146, the initial confirmation status is “unconfirmed”. The second entity that is party to the newly created license 136 is then given the opportunity to confirm or deny the newly created license 136. Upon confirmation or denial of the newly created license 136, a confirmation status associated therewith is altered to “confirmed” or “denied” status as is appropriate.

In addition to creating and maintaining the licenses 136, the license repository 123 also provides notification of various events that may occur to the various entities included in the license repository 123. For example, assuming that a first entity creates a new license 136 in the license repository 123, the second entity that is party to the new license 136 is notified of such action. Specifically, due to the fact of the licensee profile 139 or licensor profile 143 associated with the second entity includes a point of contact, the license repository can inform the second entity of the creation of the new license 136. The second entity is thus provided the opportunity to either confirm or deny the newly created license 136. The license repository 123 then sends notification to the originating party that the newly created license 136 was confirmed or denied.

In addition, where existing licenses 136 are unilaterally altered by a respective licensee 141 or licensor 146, notification to the second entity party to the modified license 136 may thus be transmitted using the point of contact. Thus, second entities are kept informed of any new licenses 136 or modifications to existing licenses 136. In this manner, the license repository 123 maintains the licenses 136 based upon the actions taken by the various licensees 141 and licensors 146.

In order to create a new license 136, modify an existing license 136, or perform some other action, a respective entity may access the information maintained within the license repository 123 including the licenses 136, licensee profiles 139, and licensor profiles 143 by manipulating the browser 166 on the client 106. Specifically, an entity may manipulate the browser 166 to access the various pages 129 stored on the license repository server 103. From the pages 129, the browser 166 generates and displays the screens 131 on the display device 169. The screens 131 provide various graphical user interfaces by which an entity can perform various functions that will be described in detail with respect to figures that follow. The control logic 126 provides the functionality to read and write information from and to the database 133 in response to various actions taken on the part of a licensee 141 or a licensor 146 as can be appreciated by those with ordinary skill in the art.

In order to serve up the pages 129, a web server or other networking technology may be employed within the license repository 123. In this respect, the pages 129 may be expressed in hypertext markup language (HTML), Extensible Markup Language (XML), or other markup language. The pages 129 may be transmitted from the license repository server 103 using the Transmission Control Protocol/Internet Protocol where the network 109 is the Internet. Also, other protocols may be employed for different networking technologies as may be appreciated by those with ordinary skill in the art.

In addition, the license for repository 123 maintains an identifier for each one of the entities that are maintained in the database 133, whether they are licensees 141 or licensors 146. Also, the licensees 141 and licensors 146 each must use a password or other security measure to access information in the license repository 123. For example, one of the pages 129 may be a security log-in page that requires a user to identify themselves by their assigned identifier as well as entering an appropriate password to gain access to the information within the license repository 123. There are various systems available on the market to ensure secure access to the license repository 123 as is generally known by those skilled in the art and, consequently, such measures are not described herein in detail.

Associated with each of the licensees 141 and licensors 146 and maintained in the database 133 are predefined permissions. The permissions that are granted to licensees 141 are different than the permissions granted to licensors 146. The permissions that are granted to the licensees 141 and the licensors 146 respectively, determine what access the respective licensees 141 and licensors 146 have to various information contained within the license repository 123. Also, the permissions dictate what actions the licensees 141 and licensors 146 can take with respect to the information contained within the license repository 123 such as, for example, the ability to alter licenses 136, licensee profiles 139, or licensor profile 143 as well as other actions.

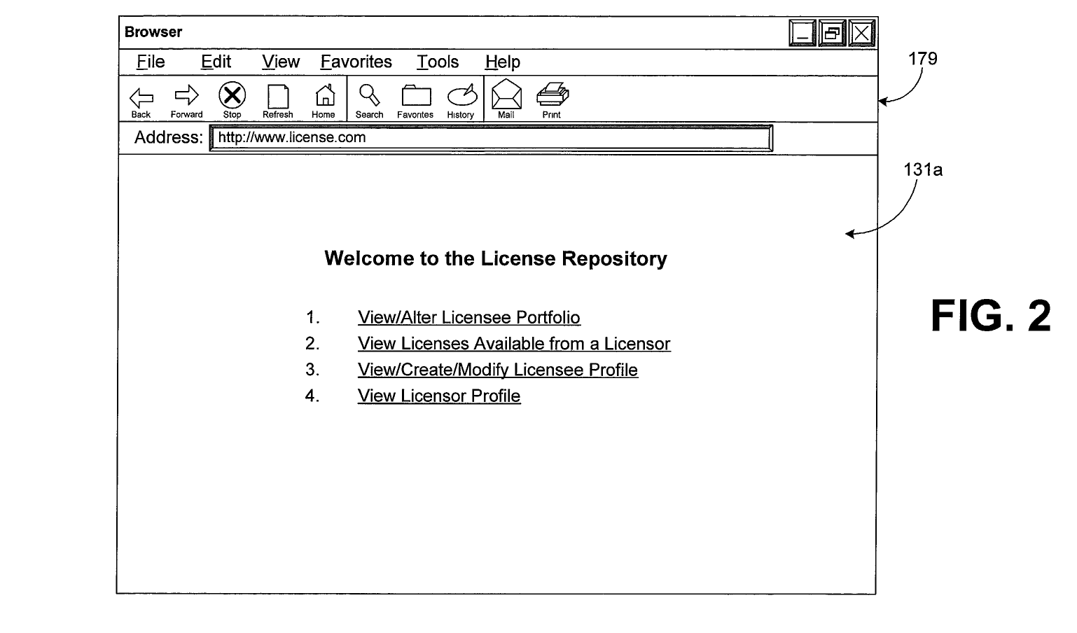

Turning then to FIG. 2, shown is the browser GUI 179 that depicts a licensee introductory screen 131a according to an aspect of the present invention. The licensee introductory screen 131a provides four options for a licensee 141 (FIG. 1) who logs into the license repository 123 (FIG. 1). In logging into the license repository 123, the licensee 141 (FIG. 1) identifies themselves according to their unique identifier as well as a password or other security measure. In this respect, only the options shown in the licensee introductory screen 131a are provided to the licensee 141 having identified themselves as a licensee 141 in the first place. The first option is “View/Alter Licensee Portfolio” that involves viewing all of the licenses 136 to which the licensee 141 is a party. Option 2 is “View Licenses Available from a Licensor” which provides a licensee 141 with the ability to view various license products offered by a particular licensor 146 (FIG. 1) that the respective licensee 141 may wish to purchase. The third option is to “View/Create/Modify Licensee Profile” in which the licensee 141 may create and view their licensee profile 139 assuming that they are a new licensee 141, or they can view and modify their existing license profile 139. Finally, the last option includes “View Licensor Profile” which provides access to licensees 141 of identified licensor profiles 143 so that they may obtain the pertinent information desired in the licensor profile 143 as needed. This might be the case, for example, if a licensee 141 wishes to contact a respective licensor 146 directly, etc.

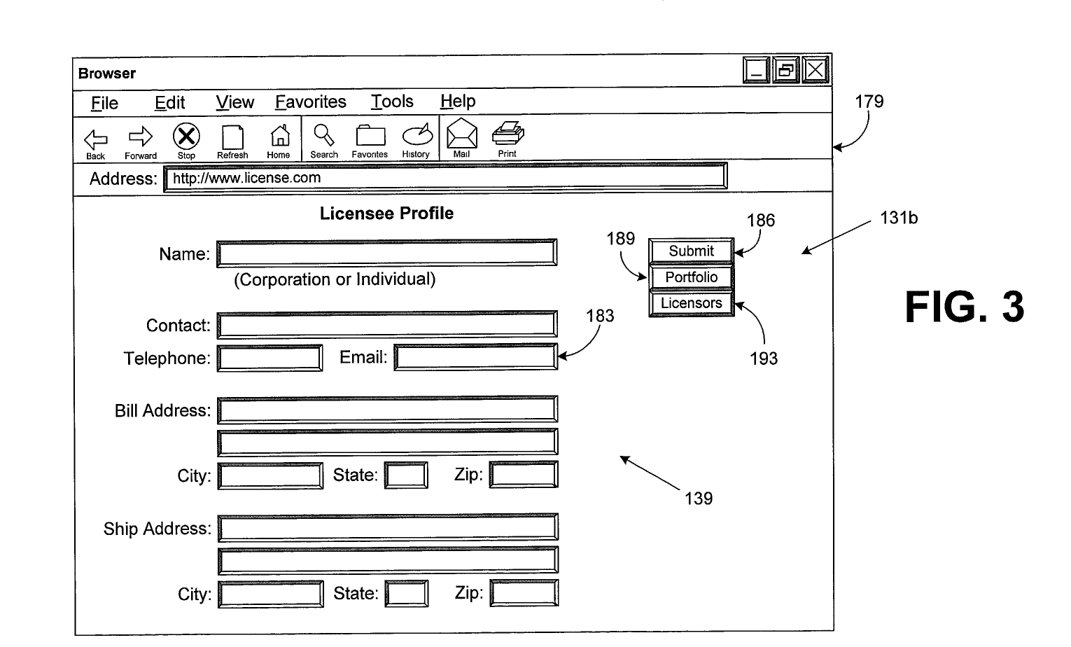

With reference to FIG. 3, shown is a licensee profile screen 131b according to an aspect of the present invention. The licensee profile screen 131b depicts a licensee profile 139 as may have been selected in option three in the licensee introductory screen 131a (FIG. 2). The licensee profile 139 includes various fields that contain information such as, for example, the name of the entity that is the licensee 141 whether a corporation or an individual, a contact person as well as a telephone number and/or an email address of the contact person. Also a billing address and shipping address of the licensee 141 may be listed. The licensee profile 139 specifically includes a point of contact 183 according to an aspect of the present invention. The point of contact 183 may be, for example, the email address, or it may be another address or number such as a telephone number, fax number or other means by which the particular licensee 141 may be contacted. The point of contact 183 provides the license repository 123 with the ability to send messages to respective licensees 141 as is appropriate during the course of the operation of the license repository 123 as will be discussed. The point of contact is specified by a respective licensee 141 and similarly by licensors 146 when their respective profiles 139 and 143 (FIG. 1) are created. Other information may be included in the licensee profile 139 as needed to perform the various functions of the license repository 123 (FIG. 1).

In the discussion that follows, the various screens 131 discussed herein include buttons and other graphical devices that may be manipulated by positioning a cursor thereon with the mouse 176 (FIG. 1) and pressing a button on the mouse 176. The buttons and other graphical devices may also be manipulated in other ways that are generally known to those skilled in the art. The act of manipulating the buttons or other graphical devices is defined herein as “clicking” on the button or graphical device, such terminology being used hereafter.

The licensee profile screen 131b also includes a “Submit” button 186, a “Portfolio” button 189, and a “Licensors” button 193. A licensee 141 with proper permissions may modify any entry in the licensee profile screen 131b and then click on the Submit button 186 to submit the modification to the license repository 123. The licensee 141 may click on the Portfolio button 189 when they wish to view their associated licensee portfolio as will be described. The licensee 141 may click on the Licensors button 193 in order to view the potential licensors 146 and their licensed product offerings so as to create new licenses 136.

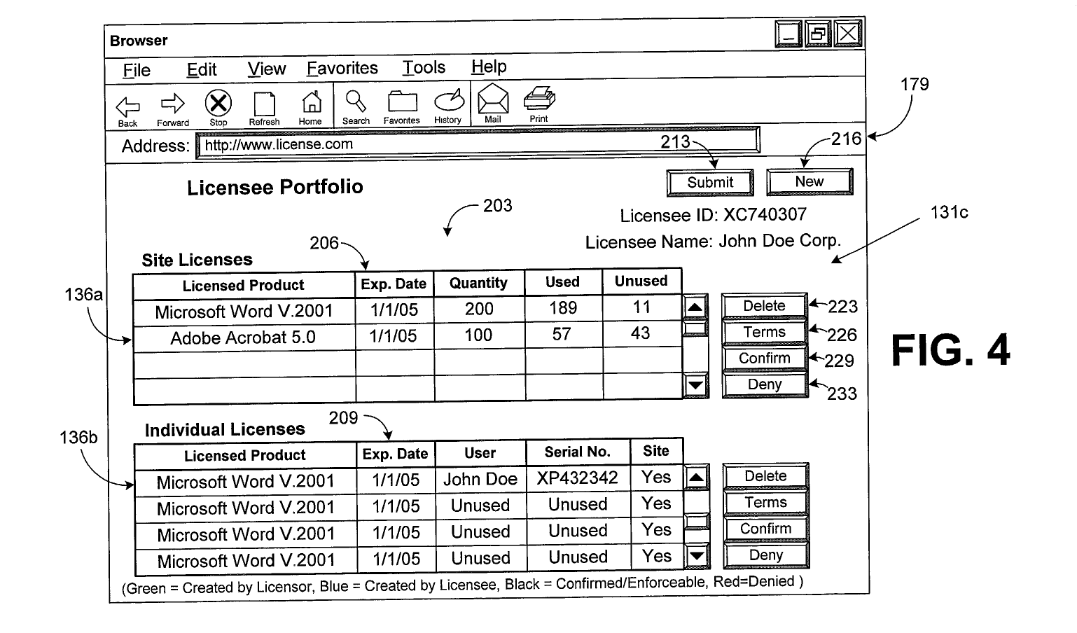

With reference to FIG. 4, shown is a licensee portfolio screen 131c that is generated on the display device 169 (FIG. 1) by the browser 166 (FIG. 1) from a page 129 (FIG. 1) that was downloaded from the license repository 123 (FIG. 1) to the client 106 (FIG. 1). As shown, the licensee portfolio screen 131c depicts a licensee portfolio 203 that includes a site license register 206 and an individual license register 209. In this respect, the licenses 136 include site licenses 136a and individual licenses 136b. A given site license 136a may include a number of individual licenses 136b. The site license register 206 lists all site licenses 136a held by a particular licensee 141. The individual license register 209 lists the individual licenses 136b that are held by the same licensee 141.

In this respect, the site license register 206 lists various information relating to the site licenses 136a such as the licensed product name, expiration date of the license, quantity of individual licenses 136b in the site license 136a, the number of used individual licenses 136b in the site license 136a, and the number of unused licenses 136b in the site license 136a. Also other information may be recorded in the site license register 206.

The individual license register 209 lists various information relating to the individual licenses 136b, including the licensed product name, expiration date of the license, the use status of the license (if it is part of a site license 136a), and whether the individual license 136b is part of a site license 136a. Note that if the license is for software, the individual license register 209 might include a field to list the serial number of the corresponding computer upon which the software runs, etc. Alternatively, the software might run from a network rather than individual computers, etc. Note that if a user alters the use status of a particular individual license 136b that is part of a site license 136a, then the corresponding used and unused numbers are modified for the corresponding site license 136a by the license repository 123.

In order to modify any one of the site licenses 136a or the individual licenses 136b, a user need only enter the appropriate information in the appropriate spaces and click on the Submit button 213 to transmit such changes to the license repository 123. The license repository 123 responds by writing the modified license information to the database 133 and then generates and transmits notification to the second entity that is party to the modified license(s) 136.

If a licensee 141 wishes to create a new license 136, whether site or individual, then the licensee 141 clicks on the new button 216. This causes the downloading of a separate page 129 (FIG. 1) from the license repository from which appropriate screens are generated to facilitate the creation of a new license 136.

The licensee portfolio screen 131c also includes four different buttons relating to both the site license register 206 and the individual license register 209, respectively. These buttons include a “Delete” button 223, a “Terms” button 226, a “Confirm” button 229, and a “Deny” button 233. To delete a specific license 136a/136b, the licensee 141 may highlight the respective license 136a/136b and click on the Delete button 223. Also, by highlighting a respective license 136a/136b and clicking on the Terms button 226, a user may view the specific terms of that license in a separate screen 131 (FIG. 1) that presents the text of the selected license 136a/136b. Such a screen is generated from a separate page 129 that is not described herein in detail.

A licensee 141 may confirm or deny a license 136a/136b created by a licensor 146. To do so, the licensee 141 may highlight a specific license and then click on either the Confirm button 229 or the Deny button 233. A corresponding message is sent to the license repository 123 that responds by altering the confirmation status of the respective license 136 accordingly. The actual confirmation status of the licenses 136 is noted by a color-coding scheme. Specifically, a license 136 that was created unilaterally by a licensor 146 is depicted in the site license register 206 or the individual license register 209 in green text. This is because the license 136 was created unilaterally and requires confirmation from the corresponding licensee 141.

The licensee 141 may then highlight the respective license 136 that is depicted in green text and click on the Confirm button 229 to confirm that the license has been properly created by the licensor 146. At such time, a message is transmitted to the license repository 123 confirming the respective license 136. The license repository 123 responds by modifying the confirmation status associated with the respective license 136 and then re-transmitting the page 129 from which the licensee portfolio screen 131c is generated. In this subsequent screen, the respective license is depicted in black text indicating the “confirmed” confirmation status. On the other hand, the licensee 141 may click on the deny button 233 in order to deny that a license 136 was properly created by the licensor 146. In such case, a message is transmitted to the license repository 123 denying the license 136 in question and the license 136 is ultimately depicted in red text with a corresponding change in the license confirmation status.

In the case of all actions taken by the licensee 141 when viewing the licensee portfolio screen 131c described above with respect to any license 136, the license repository 123 responds by generating notification that is sent to the corresponding licensor 146 informing that entity of the action taken. This is possible as the point of contact of the licensor 146 is maintained in the license repository 123.

In addition, the licensee portfolio screen 131c may be viewed only by the respective licensee 141. Thus, licensors 146 and non-authorized licensees 141 are restricted from viewing a respective licensee portfolio screen 131a without logging into the license repository 123 with the correct password, etc.

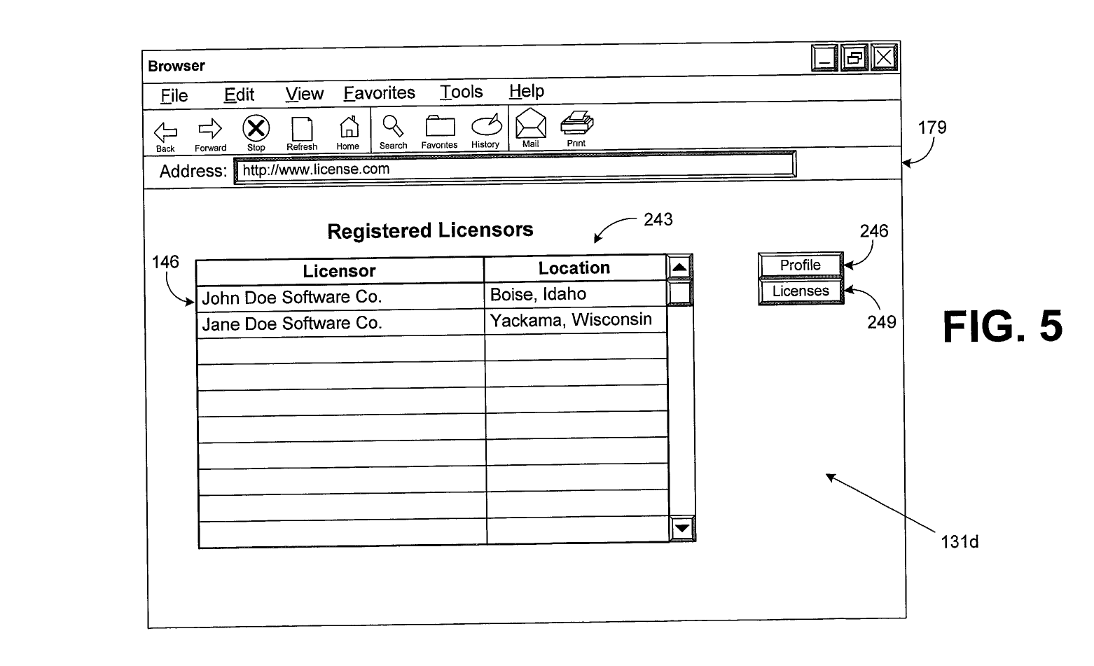

Turning to FIG. 5, shown is a licensor registry screen 131d that is generated from a page 129 (FIG. 1) downloaded from the license repository 123 when a licensee clicks on the new button 216 (FIG. 4) to create a new license 136 (FIG. 1). The licensor registry screen 131d includes a licensor registry 243 that depicts all of the potential licensors 146 contained within the license repository 123 (FIG. 1). The listing of the licensors 146 in such a manner is provided so that a respective licensee 141 (FIG. 1) may select a respective licensor 146 with which to create a license 136. Specifically, the licensee 141 may highlight the respective licensor 146 in the licensor registry 243 by clicking thereon. Thereafter, the user may click on a Profile button 246 or a Licenses button 249 as shown.

Upon clicking the Profile button 246, the browser 166 then downloads another page 129 from which a screen is generated that depicts the licensor profile 143 for the selected licensor 146. Alternatively, if the licensee 141 clicks on the Licenses button 249, then another page 129 is downloaded from the license repository 123 from which a screen is generated that depicts the license products offered by the respective selected licensor 146. Also, it should be noted that a licensee 141 may reach the licensor registry screen 131d by clicking on the second and fourth options of licensee introductory screen 131a (FIG. 2) as was described. Thus, the licensor registry screen 131d provides a means by which a licensee 141 may select a respective licensor 146 for the purposes of implementing various functions of the license repository 123 with respect to that licensor 146.

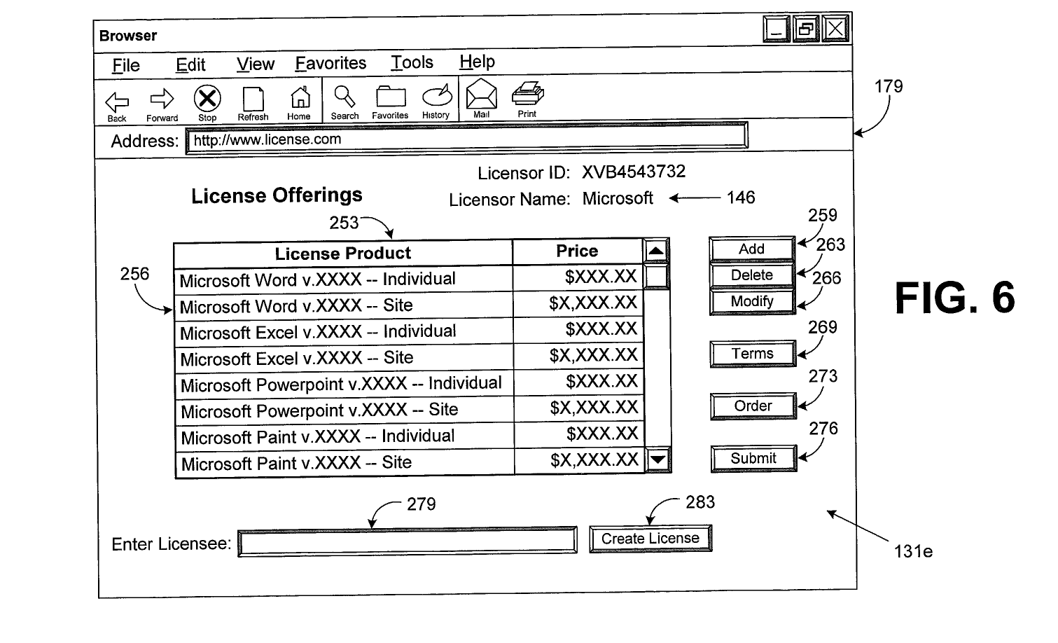

With respect to FIG. 6, shown is a license offering screen 131e according to an aspect of the present invention. The license offering screen 131e is rendered by the browser 166 (FIG. 1) on the display device 169 (FIG. 1) from one of the pages 129 (FIG. 1) downloaded from the license repository 123 (FIG. 1). In this respect, the license-offering screen 131e includes a licensed products offerings list 253 that shows a number of licensed products 256 offered by a respective licensor 146. The license offering screen 131e may be accessed by the licensor 146 associated with the licensed products 256 or by registered licensees 141 with the license repository 123.

Depending on who accesses the license-offering screen 131e, specific permissions apply as to what actions or functions may be performed thereby. Specifically, a number of buttons are provided in the license offering screen 131e including an “Add” button 259, a “Delete” button 263, and a “Modify” button 266. By virtue of the Add, Delete, and Modify buttons 259, 263 and 266, a licensor 146 that offers the licensed products 256 may add or delete licensed products 256 to or from those listed. Also, the licensor 146 may modify a specific license product by highlighting such licensed product 256 and clicking on the modify button 266. In performing the add or modify functions, the licensor 146 may be presented with other screens generated from pages 129 from the license repository 123 that are not described herein in detail. Such screens give the licensor 146 to ability to specify or modify all aspects of such license offerings including license text and other aspects, etc.

Note that licensees 141 are not granted permissions based upon their login password and licensee identifier to add, delete, or modify any of the licensed products 256. In this respect, the Add, Delete, and Modify buttons 259, 263, and 266 are not shown or are dimmed, etc. Note that anytime a respective licensee 141 or licensor 146 views a screen with functional items for which they do not have permission to activate, such functional items such as buttons and the like are dimmed accordingly.

To view the terms dictated by a specific license 136, an entity may click on the “Terms” button 269. This causes a page 129 to be downloaded from the license repository 123 from which a separate screen is rendered on the display device 169 to view the text of the respective license 136. If a licensee 141 wishes to order a respective license product 256, then the licensee 141 highlights the respective licensed product 256 by clicking thereon and then clicking the “Order” button 273. This causes the license repository 123 to automatically create the license 136 for the individual licensee 141. Once a specific license 136 is ordered, then the license repository 123 sends a corresponding notification to the respective licensor 146. Also, the license offering screen 131e includes a submit button 276 that is clicked on by a licensor 146 to submit all changes made to the license products 256 to the license repository 123.

The license-offering screen 131e also provides for the capability of a licensor 146 to create a license with a respective licensee 141. Specifically, the license-offering screen 131e includes a licensee field 279 into which a licensor 146 enters the name or licensee identifier of a respective licensee 141 with which a license is to be created. The licensor 146 also highlights one of the licensed products 256 in the licensed product offering list 253 to indicate which license 136 to be generated. Thereafter, the licensor 146 then clicks on a “Create License” button 283 to create a license 136 between the licensee 141 listed in the licensee field 279 and the respective licensor 146. Upon receiving the new license 136 between the licensor 146 and the licensee 141, the license repository 123 sends corresponding notification to the second entity that is party to the license 136. This entity may then confirm or deny the license 136 as was described with reference to FIG. 4.

In ordering and creating a new license 136, a respective licensee 141 or licensor 146 may be led through a series of screens that allow the entity to specify any and all unique or optional features of the license 136. Such information is maintained in the database 133 (FIG. 1).

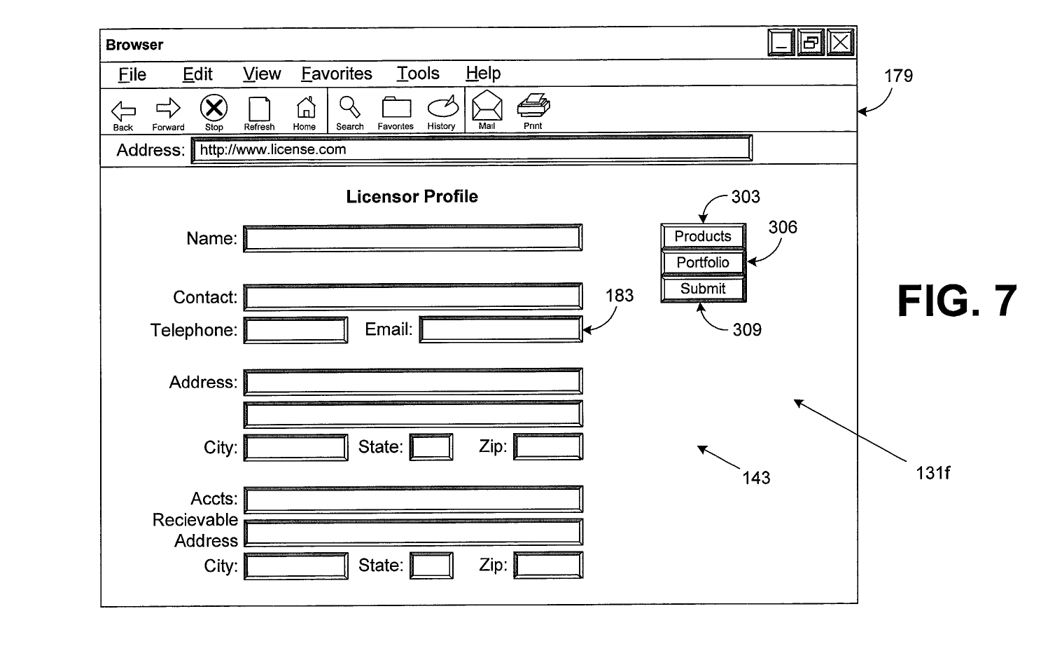

With reference to FIG. 7, shown is a licensor profile screen 131f that is generated on the display device 169 (FIG. 1) by the browser 166 (FIG. 1) from a page 129 (FIG. 1) that was downloaded from the license repository 123 (FIG. 1) to the client 106 (FIG. 1). The licensor profile screen 131f is similar in many respects to the licensee profile screen 131b (FIG. 3). In this respect, the licensor profile 143 is depicted with several fields in a similar manner to the licensee profile screen 131b (FIG. 3). Note that the licensor profile screen 131f includes the point of contact 183 that may be, for example, an email address, telephone number, facsimile number, or other means of contacting the licensor 146 (FIG. 1) to provide notification for the various events that may occur during the course of the operation of the license repository 123. The licensor profile screen 131f also includes a “Products” button 303, a “Portfolio” button 306, and a “Submit” button 309. The licensor 146 may click on the “Products” button 303 in order to view the license offering screen 131e associated with the current licensor 146 that is described in the current licensor profile screen 131f.

Depending on the permissions granted, a licensee 141 may have access to the licensor profile screen 131f to obtain information about the licensor 146. However, the licensee 141 may not have permission to modify any of the entries in the licensor profile 143. In this respect, the licensee 141 or licensor 146 may click on the products button 303 to view the products offered by the specific licensor 146 described. A licensor 146 that accesses their respective licensor profile 143 may click on the portfolio button 306 to view their respective license portfolio. However, it may be the case that such access is not provided to licensees 141. The Submit button 309 may be clicked on by a respective licensor 146 to submit any modifications of the licensor profile 143 to the license repository 123 where such modifications are written in the database 133. Also, the Submit button 309 may be clicked to store a new licensor profile 143.

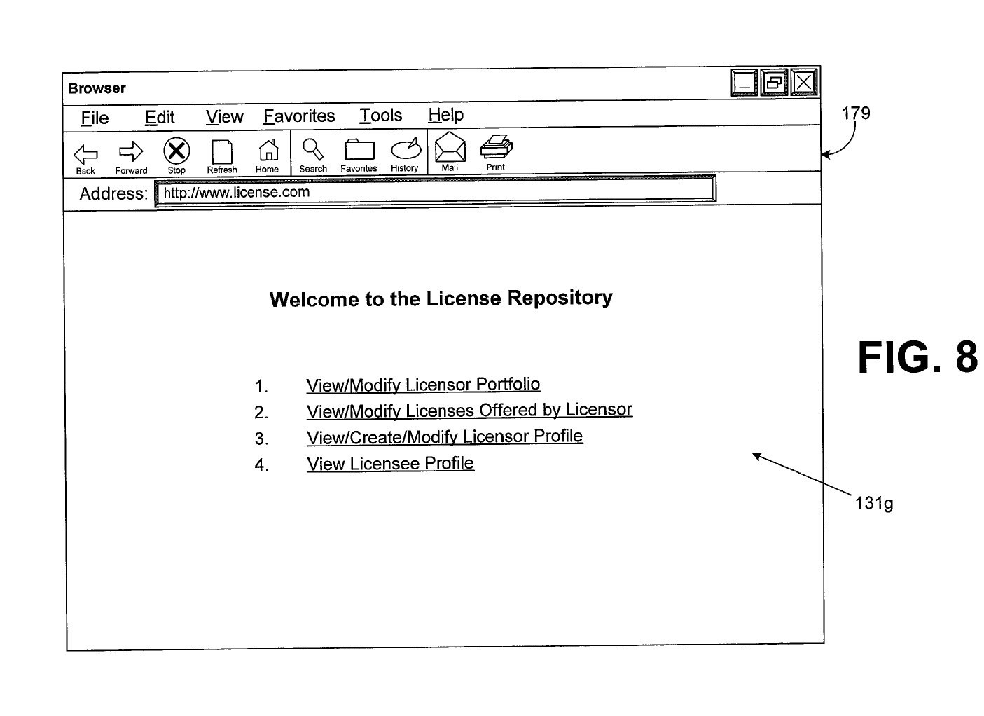

With reference to FIG. 8, shown is a licensor introductory screen 131g that is generated on the display device 169 (FIG. 1) by the browser 166 (FIG. 1) from a page 129 (FIG. 1) that was downloaded from the license repository 123 (FIG. 1) to the client 106 (FIG. 1). Assuming that a particular licensor 146 (FIG. 1) is logged into the license repository 123 identifying themselves as a licensor 146 and passing through such security measures as are appropriate, the licensor 146 is presented with the licensor introductory screen 131g. The licensor introductory screen 131g provides four options for a licensor 146, although other options may be included. The first of the four options includes a “View/Modify Licensor Portfolio” option that, upon clicking thereon, the licensor 146 is presented with a screen that provides access to their portfolio of licenses 136 to which the licensors are a party as will be discussed. The second option is labeled “View/Modify Licenses Offered by Licensor” that, upon clicking thereon, a licensor 146 is presented with the license offering screen 131e (FIG. 6) discussed previously.

The third option is a “View/Create/Modify Licensor Profile” option that may be clicked on by a licensor 146 in order to view the licensor profile screen 131f (FIG. 7). In the licensor profile screen 131f, the licensor 146 may view, create, or modify a corresponding licensor profile 143 (FIG. 7) as was described. The licensor 146 may also click on the “View Licensee Profile” option that causes the licensee profile screen 131b to be rendered on the display device 169 (FIG. 1) by the browser 166 (FIG. 1). Note that other options may be provided to the licensor 146, depending upon what access a particular licensor 146 is to be given to the information contained within the license repository 123. Specifically, other screens might be made available and various options contained within such screens may be made available to licensors 146 based upon the permissions provided to the respective licensors 146 in light of their security login as described previously.

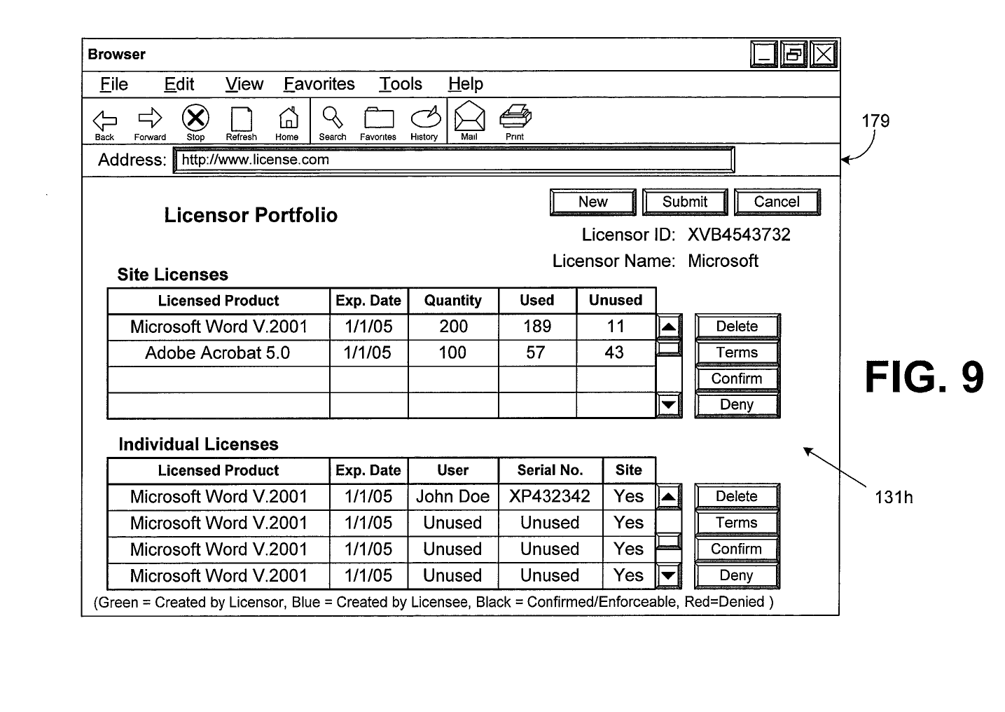

With reference to FIG. 9, shown is a licensor portfolio screen 131h that is generated on the display device 169 (FIG. 1) by the browser 166 (FIG. 1) from a page 129 (FIG. 1) that was downloaded from the license repository 123 (FIG. 1) to the client 106 (FIG. 1). The licensor portfolio screen 131h is very similar in most respects to the licensee portfolio screen 131c (FIG. 4), although the licenses 136 depicted therein are those in which the respective licensor 146 (FIG. 1) is a party. Consequently, the licensor portfolio screen 131h is not described in great detail herein.

With respect to the screens depicted in FIGS. 2-9, it is understood that the graphical devices and other characteristics of such screens are provided only as an example of the concepts of the present invention. Specifically, one with ordinary skill in the art will appreciate that the same functions and displays may be accomplished with screens that differ dramatically from those shown. For instance, graphical devices other than buttons may be employed to provide licensors 146 and licensees 141 with the capability of navigating from one screen to the other and to accomplish the various tasks underlying the screens themselves. Such variations are within the scope of the present invention as described and claimed herein.

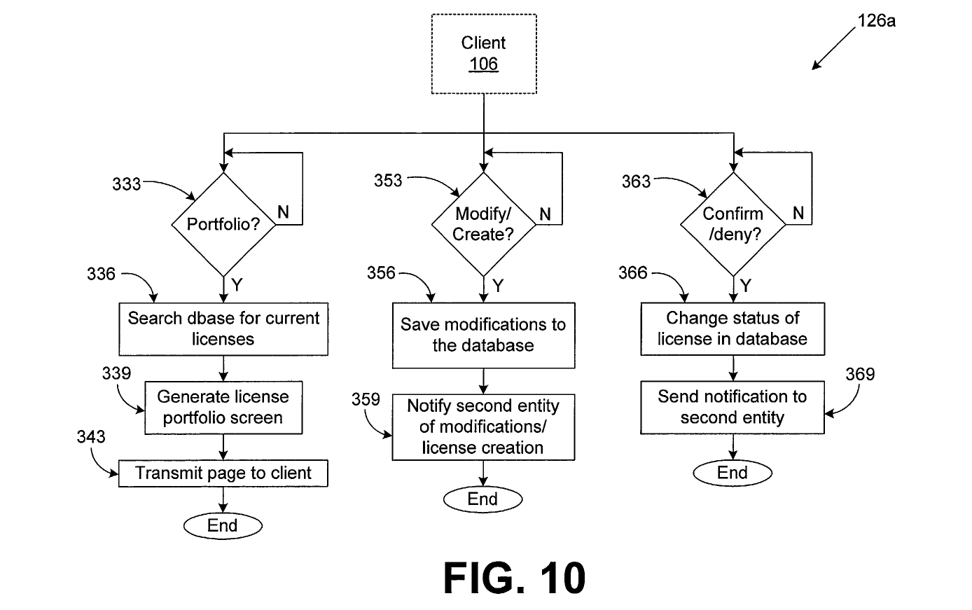

In the following discussion, FIGS. 10, 11, and 12 depict flow charts that illustrate some of the functionality of the control logic 126 (FIG. 1) according to an aspect of the present invention. It is understood that the control logic 126 also provides for functionality other than that described during the general operation of the license repository 123 (FIG. 1) in interfacing with various licensees 141 (FIG. 1) and licensors 146 (FIG. 1) through various client devices 106 (FIG. 1). Such functionality is apparent to one skilled in the art upon viewing the screens of FIGS. 2-9 and falls within the scope of the present invention. In addition, in performing the various tasks germane to the license repository 123, the control logic 126 may comprise a number of servlets or other logic as can be appreciated by those with ordinary skill in the art that reacts to requests and messages received from the client 106 (FIG. 1).

With specific reference to FIG. 10, shown is control logic 126a that is executed in the license repository server 103 in interfacing with a client 106 that rendered the licensee or licensor portfolio screens 131c (FIG. 4) or 131h (FIG. 9) as described previously. Alternatively, the flow charts of FIG. 10 may be viewed as steps in a method implemented in the license repository server 103. The control 126a generally waits to receive an appropriate message from the client 106. In order to generate the licensee portfolio screen 131c or the licensor portfolio screen 131h, a user clicks upon the appropriate option in the licensee introductory screen 131a (FIG. 2) or the licensor introductory screen 131g (FIG. 8). Such action causes a request to be transmitted from the respective client 106 to the license repository server 103 and is supplied to the control logic 126 of the license repository 123. In block 333, the control logic 126a determines whether the message is a request for a particular licensor or licensee portfolio that lists all of the licenses 136 to which the respective entity is a party. Assuming that the message is such a request, the control logic 126a proceeds to box 336 in which the database 133 (FIG. 1) is searched for the licenses 136 (FIG. 1) to which such entity is a party. Thereafter, in box 339, the respective page 129 corresponding to the license portfolio screen 131c or 131h is generated in the license repository server 103. Then, in block 343 the page 129 is transmitted to the requesting client 106 for rendering on the display device 169 (FIG. 1) by the browser 166 (FIG. 1).

The control logic 126a also includes the ability to modify records within the database 133 based on inputs from either the licensee 141 or the licensor 146 by manipulating the licensee portfolio screen 131c or the licensor portfolio screen 131h appropriately. In this respect, beginning with box 353, the control logic 126a determines whether a modification is to be made to any existing information in the database 133 based upon an input received from the client 106 based upon the actions of a respective licensee 141 or licensor 146. If so, then the control logic 126a proceeds to box 356 in which the modifications from the client 106 are saved in the database 133. Note that in addition to modifications to existing data, the control logic 126a may also store new data to establish a new licensor 146, licensee 141, or license 136 as is appropriate. Thereafter, in block 359, the control logic 126a notifies the respective entity that is party to any license agreements 136 that are affected by any of the modifications that occur in block 356.

In addition, the control logic 126a may be executed to modify and otherwise maintain the confirmation status of a respective license 136 during the course of the operation of license repository 123. In this respect, beginning with block 363, the control logic 126a determines whether a message received from a respective client 106 relays a unilateral creation, confirmation, or denial of a specific license 136. If such is the case, then the control logic 126a proceeds to box 366 in which the confirmation status of the license 136 in question is set or modified appropriately in the database 133. For example, assuming a new license 136 that had been created by a respective licensee 141 was just confirmed by the respective licensor 146, then the confirmation status of the license 136 is changed from “unconfirmed” to “confirmed”. Thereafter, in block 369, notification is transmitted to the second entity involved in the respective license 136 as to the change in status. Specifically, in the example provided previously, the license repository 123 generates a confirmation message that is transmitted to the licensee 141 that the status has been changed from “unconfirmed” to “confirmed.”

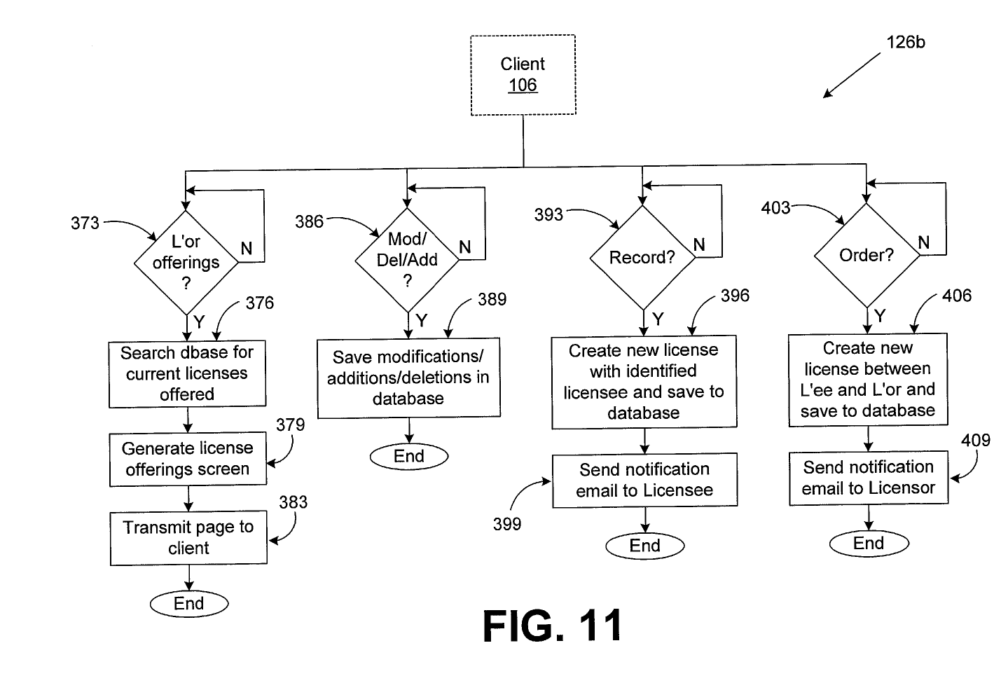

With reference to FIG. 11, shown are several portions of the control logic 126b that are implemented in the licensed repository server 103 (FIG. 1) in generating and manipulating the license offering screen 131e (FIG. 6). Alternatively, the flow charts of FIG. 11 may be viewed as steps in a method implemented in the license repository server 103. Specifically, assuming that an entity has identified a respective licensor 146 (FIG. 1) in the licensor registry 243 (FIG. 5), then the license offering screen 131e is generated on the display device 169 (FIG. 1). In generating the license offering screen 131e, the control logic 126b begins with block 373 in which it is determined whether the various license offerings by a specified licensor 146 have been requested from a respective client 106. If such is the case, then the control logic 126b proceeds to box 376 in which the database 133 is searched for all current licensed products 256 (FIG. 6) offered by a respective licensor 146.

Then, in box 379, a page 129 corresponding to the license offering screen 131e is generated in the license repository 123. Thereafter, the page 129 is transmitted to the respective client 106 in box 383 to be rendered as the license offering screen 131e on the display device 169. Assuming that the license offering screen 131e has been downloaded to the client, then in box 386, if any modifications, deletions, or additions to the licensed products 256 occurs, then the control logic 126b proceeds to box 389 in which the modifications, deletions, or additions are saved in the database 133 (FIG. 1).

Assuming in some situations that a licensor 146 accesses the license offering screen 131e in order to record a new license 136, then the licensor 146 enters the name or other identifier of the licensee in the licensee field 279 (FIG. 6) and click on the create license button 283 (FIG. 6). In response, in block 393, the control logic 126b waits to receive the request that the respective license 136 is to be recorded. Assuming such is the case, then the control logic 126b proceeds to box 396 in which the new license 136 is created with the identified licensee 141 and saved to the database 133 (FIG. 1). Thereafter the control logic 126b proceeds to box 399 in which notification is transmitted to the respective licensee 141 that is party to the newly created license 136.

In another circumstance, a licensee 141 that views the license offering screen 131e may select a respective licensed product 256 on the license product offering list 253 and thereafter click on the order button 273 to order the particular license 136. If such is the case, then the control logic 126b receives the request for the order and in block 403, the control logic 126b proceeds to box 406 in which a new license 136 is created between the respective licensee 141 and the licensor 146. Such licenses then stored in the database 133. Then, the control logic 126b proceeds to box 409 in which notification is sent to the licensor 146 that is party to the newly created license 136.

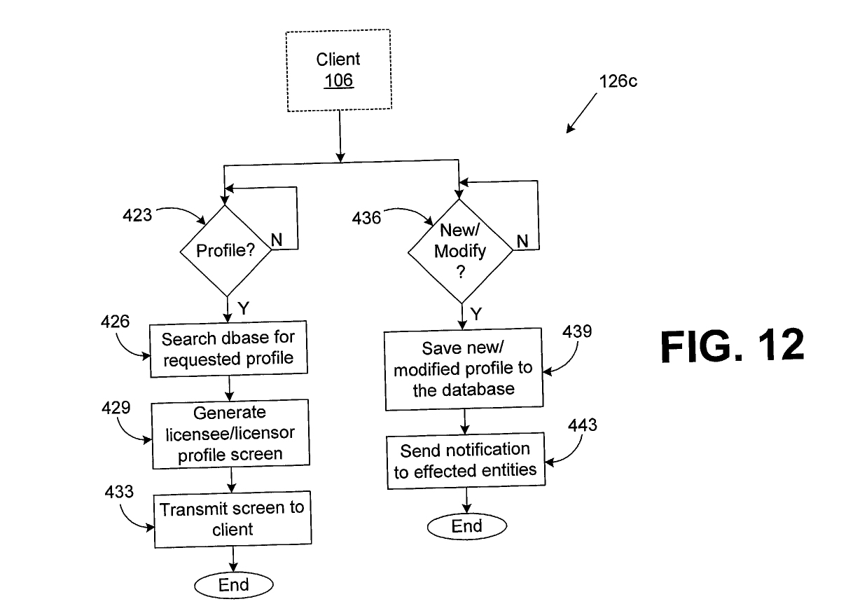

Turning then to FIG. 12, shown are several portions of the control logic 126c that are implemented in the licensed repository server 103 (FIG. 1) in generating and manipulating either the licensee or licensor profile screens 131b (FIG. 3) or 131f (FIG. 7). Alternatively, the flow charts of FIG. 12 may be viewed as steps in a method implemented in the license repository server 103.

Assuming that a user has clicked on options three or four in either the licensee introductory screen 131a (FIG. 2) or the licensed introductory screen 131g (FIG. 8), then the control logic 126c progresses from box 423 to box 426 in which a database 133 (FIG. 1) is searched for the requested profile 139/143 (FIG. 1). Thereafter, in block 429, the control logic 126c generates the page 129 (FIG. 1) that corresponds to the respective profile screen 131b/131f. Thereafter, in block 433, the control logic 126c transmits the page 129 to the client 106 (FIG. 1) to be rendered on the display device 169 (FIG. 1). In this manner, the licensee profile screen 131b and/or the licensor profile screen 131f may be viewed and manipulated on the display screen 169 of the client 106.

In block 436, the control logic 126c determines whether a respective licensee or licensor profile 139 or 143 has been newly created or modified by a respective licensee 141 or licensor 146. If such is the case, then the control logic 126c proceeds to box 439 in which the newly created or modified profile 139 or 143 is saved to the database 133. Thereafter, in box 443, notification is sent to all entities that might have been affected by any modifications created using the licensor or licensee profile screens 131b and 131f.

Although the license repository 123 of the present invention is embodied in software or code executed by general purpose hardware as discussed above, as an alternative the license repository 123 may also be embodied in dedicated hardware or a combination of software/general purpose hardware and dedicated hardware. If embodied in dedicated hardware, the license repository 123 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 10-12 show the architecture, functionality, and operation of an implementation of the license repository 123. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although flow charts of FIGS. 10-12 show a specific order of execution, it is understood that the order of execution may differ from that which is depicted. For example, the order of execution of two or more blocks may be scrambled relative to the order shown. Also, two or more blocks shown in succession in FIGS. 10-12 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flow charts of FIGS. 10-12 are relatively self-explanatory and are understood by those with ordinary skill in the art to the extent that software and/or hardware can be created by one with ordinary skill in the art to carry out the various logical functions as described herein.

Also, where the license repository 123 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the license repository 123 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A method for maintaining a license repository, comprising:
maintaining a number of entities in the license repository in a server, the number entities including a number of licensors and a number of licensees;
generating a number of licenses between respective pairs of the licensees and the licensors based upon an input from at least one of the licensees and the licensors, respectively; and
maintaining the licenses in the license repository.

2. The method of claim 1, wherein the step of maintaining the number of entities in the license repository in the server further comprises maintaining a profile for each of the entities, each of the profiles including point of contact for at least one of the entities in the license repository.

3. The method of claim 1, wherein the step of generating the number of licenses between respective pairs of the licensees and the licensors based upon the input from the at least one of the licensees and the licensors, further comprises:
generating a first one of the licenses based upon a unilateral input by a first one of the entities; and
notifying a second one of the entities that is party to the first one of the licenses of the creation of the first one of the licenses.

4. The method of claim 1, further comprising maintaining a confirmation status of at least one of the licenses in the license repository.

5. The method of claim 2, further comprising:
modifying a first one of the profiles in the license repository based upon a modification input received from a first one of the entities; and
notifying a second one of the entities that is party to one of the licenses with the first one of the entities of the modifying of the first one of the profiles.

6. The method of claim 4, further comprising updating the confirmation status of the at least one of the licenses based upon a confirmation status input received from one of the entities.

7. The method of claim 1, further comprising maintaining a number of license products associated with at least one of the licensors in the license repository.

8. The method of claim 7, further comprising including an additional one of the number of license products in the license repository based upon a license product input from the at least one of the licensors.

9. A program embodied on a computer-readable medium for maintaining a license repository, comprising:
code that maintains a number of entities in the license repository, the number entities including a number of licensors and a number of licensees;
code that generates a number of licenses between respective pairs of the licensees and the licensors based upon an input from at least one of the licensees and the licensors, respectively; and
code that maintains the licenses in the license repository.

10. The program embodied on a computer-readable medium of claim 9, wherein code that maintains the number of entities in the license repository in the server further comprises code that maintains a profile for each of the entities, each of the profiles including point of contact for at least one of the entities in the license repository.

11. The program embodied on a computer-readable medium of claim 9, wherein the code that generates the number of licenses between respective pairs of the licensees and the licensors based upon the input from the at least one of the licensees and the licensors, further comprises:
code that generates a first one of the licenses based upon a unilateral input by a first one of the entities; and
code that notifies a second one of the entities that is party to the first one of the licenses of the creation of the first one of the licenses.

12. The program embodied on a computer-readable medium of claim 9, further comprising code that maintains a confirmation status of at least one of the licenses in the license repository.

13. The program embodied on a computer-readable medium of claim 10, further comprising:
code that modifies a first one of the profiles in the license repository based upon a modification input received from a first one of the entities; and
code that notifies a second one of the entities that is party to one of the licenses with the first one of the entities of the modifying of the first one of the profiles.

14. The program embodied on a computer-readable medium of claim 12, further comprising code that updates the confirmation status of the at least one of the licenses based upon a confirmation status input received from one of the entities.

15. The program embodied on a computer-readable medium of claim 9, further comprising code that maintains a number of license products associated with at least one of the licensors in the license repository.

16. The program embodied on a computer-readable medium of claim 15, further comprising code that includes an additional one of the number of license products in the license repository based upon a license product input from the at least one of the licensors.

17. A system for maintaining a license repository, comprising:
means for maintaining a number of entities in the license repository in a server, the number entities including a number of licensors and a number of licensees;
means for generating a number of licenses between respective pairs of the licensees and the licensors based upon an input from at least one of the licensees and the licensors, respectively; and
means for maintaining the licenses in the license repository.

18. The system of claim 17, wherein the means for maintaining the number of entities in the license repository in the server further comprises means for maintaining a profile for each of the entities, each of the profiles including point of contact for at least one of the entities in the license repository.

19. The system of claim 17, wherein the means for generating the number of licenses between respective pairs of the licensees and the licensors based upon the input from the at least one of the licensees and the licensors, further comprises:
means for generating a first one of the licenses based upon a unilateral input by a first one of the entities; and
means for notifying a second one of the entities that is party to the first one of the licenses of the creation of the first one of the licenses.

20. The system of claim 17, further comprising means for maintaining a confirmation status of at least one of the licenses in the license repository.

21. The system of claim 17, further comprising means for maintaining a number of license products associated with at least one of the licensors in the license repository.

22. The system of claim 18, further comprising:
means for modifying a first one of the profiles in the license repository based upon a modification input received from a first one of the entities; and
means for notifying a second one of the entities that is party to one of the licenses with the first one of the entities of the modifying of the first one of the profiles.

23. The system of claim 20, further comprising means for updating the confirmation status of the at least one of the licenses based upon a confirmation status input received from one of the entities.

24. The system of claim 21, further comprising means for including an additional one of the number of license products in the license repository based upon a license product input from the at least one of the licensors.
